(19) United States
(12) Patent Application Publication
(10) Pub. No.: US 2006/0265735 A1
(43) Pub. Date: Nov. 23, 2006

(54) Content transmission apparatus, content reception apparatus, content transmission method and content reception method

(76) Inventor: Chiyo Ohno, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/431,710

(22) Filed: May 11, 2006

(30) Foreign Application Priority Data
May 20, 2005 (JP) 2005-147484

(51) Int. Cl. H04L 9/32

(52) U.S. Cl. 726/2

(57) ABSTRACT

Disclosed are a content transmission apparatus and a content reception apparatus so constructed as to mutually authenticate before transmitting content. In authentication, the time period from the transmission of an authentication request or of authentication response to the arrival of a reception confirmation is measured; only when the measured value does not exceed a certain maximum value, encrypted content is transmitted and address information and device information specific to the apparatus are registered. For the next content transmission, there is no need of time measurement when transmitting the encrypted content. The time measurement is implemented at a suitable timing for the system to dynamically manage the registered information so as to be suitable for the current network configuration. These apparatuses can suppress unauthorized creation of copies in copy transmission through a wired or wireless LAN, allow the content transmission to be carried out only within the range of personal use, and thereby protecting copyright.

### CLAIM OF PRIORITY

The present application claims priority from Japanese Patent Application No. JP2005-147484 filed on May 20, 2005, the content of which is hereby incorporated by reference into this application.

### BACKGROUND OF THE INVENTION

The present invention relates to a content transmission apparatus, a content reception apparatus, a content transmission method and a content reception method suitable for protecting the copyright of content (video and audio etc.) to be transmitted or received through a network.

With improved processing power of a personal computer (PC) along with its increased computing speed, the built-in hard disk drive (HDD) tends to have much larger capacity than predecessors. Under such circumstances, a recent PC of a rank represented by home-use PCs can be used for recording a TV broadcast program using the HDD and viewing the program on a display of the PC.

Also with price-reduction of the high-capacity HDD, there has been introduced an HDD video-recording apparatus, as a home video-recording apparatus, that has built-in HDD for digitally recording audio/video information. In such an HDD video-recording apparatus that uses a disk as a recording medium, attention is focused on an excellent usability.

In recording equipment such as the video-recording apparatus and PC using the HDD as described above, audio/video information is recorded on the HDD fixed in the recording equipment, so that a user must carry the recording equipment itself when trying to view a recorded program in another room in the house. Thus, it has been difficult to implement an application to carry audio/video information by the medium level, which can be realized by providing a plurality of video-recording/reproduction apparatus using a replaceable recording medium such as a VTR.

In order to solve the above problem, it is conceived that a wired or wireless Local Area Network (LAN) interface is mounted on such a video-recording apparatus to allow the user to view recorded audio/video information anywhere in the house by transmitting the information to another PC or reception apparatus through a network.

Meanwhile, an example of a copy protection method adopted in the digital AV apparatus, in order-to protect copyright of information such as content, is a Digital Transmission Content Protection (DTCP) system that defines the copy protection method, for example, on an IEEE1394 bus (refer to “5C Digital Transmission Content Protection White Paper” by Hitachi, Ltd. and others).

Several technologies that implement copy protection for the copyright protection between apparatuses or networks are disclosed, for example, in JP-A-2000-287192 and JP-A-2001-358706.

### SUMMARY OF THE INVENTION

According to the above techniques, a wired or wireless LAN (Local Area Network) interface is mounted on a home video-recording apparatus through which content is transmitted to another PC or reception apparatus through a network to allow the user to view recorded audio/video information anywhere in the house. However, it has not been taken into account a copyright protection of audio/video information (content) whose copyright should be protected, so that the audio/video information recorded on the HDD has been able to be further stored on the HDD in another PC that received the information through the LAN. Thus, the audio/video information available in the prior art should have been “Copy free” content which can be freely copied.

Generally, when digitally recorded content is transmitted from one apparatus to another through a network and is recorded therein, the data quality hardly deteriorates in the course of the transmission, and a copy (duplicate) with the same quality as the content in the apparatus on the transmission side can be created in the reception side. Thus, for the audio and video data (content) whose copyright should be protected, consideration is necessary to prevent unauthorized creation of content copies beyond the range of personal use. For example, in a transmission of content between digital AV apparatuses, the copy protection is implemented in such a way that the apparatus on the content transmission side encrypts the content while sharing the information for decryption with the apparatus on the content reception side so that the content is not correctly received and decrypted by an apparatus other than the content reception apparatus which is the transmission destination.

An example of such a copy protection method adopted in digital AV apparatus is, for example, the DTCP system described in “5C Digital Transmission Content Protection White Paper” by Hitachi, Ltd. and others. In the DTCP system, the content is managed by grouping into “Copy free”, “Copy one generation”, “No more copies”, and “Copy never”. The video-recording apparatus records only the content belonging to “Copy free” and “Copy one generation”. The content of “Copy one generation” that is once recorded is treated as “No more copies”, and the content except of “Copy free” is subjected to an encryption process in the transmission side and is transmitted through the bus, thereby to prevent unlimited creation of content copies.

In the content transmission with the wired or wireless LAN, several technologies for implementing copy protection to protect copyright are disclosed based on an expanded concept of the DTCP system. For example, disclosed in JP-A-2000-287192 is a technology for applying the same method as the DTCP to a copy protection system for digital content distribution on a network. Also, disclosed in JP-A-2001-358706 is a technology for establishing a communication link between apparatuses where the content is encrypted for the purpose of the copyright protection.

Meanwhile, these technologies do not consider whether the transmission side and reception side are present in the same house, when transmitting content through the wired or wireless LAN. Rather, it generally happens that the transmission side is in a provider's site and the reception side is at home when download is carried out from a distribution server.

Thus, although the technologies are applied to a case where a user records content on the HDD of a PC or an HDD built-in video-recording apparatus and tries to transmit the content therefrom to another apparatus in the house through the LAN, when the LAN in the house is connected to the Internet, the user can receive and display the content by another apparatus installed in the house. In addition, its range extends everywhere throughout the world if connected to the Internet.

Under such circumstances, even if the copy protection is applied with the technologies as described above, when the user of the video-recording apparatus makes the recorder accessible from the Internet, any reception apparatus equipped with the copy protection can freely receive and display content, which substantially departs from the range of personal use that is the original purpose of copyright protection.

An object of the present invention is to provide a content or information transmission apparatus, reception apparatus and a content transmission method that are capable of implementing copy protection to prevent unauthorized duplication of content in the course of the content transmission using a wired or wireless LAN in the house as well as limiting the authorized viewing and duplication of content to the range of personal use.

In order to solve the above problem, an aspect of the present invention resides in a content transmission apparatus for transmitting content through a network, having: a network communications processing section for transmitting and receiving data through the network; a transmission content generation section for supplying content to be transmitted to a content reception apparatus connected through the network, to the network communications processing section; an authentication section for receiving an authentication request from the content reception apparatus and determining the authentication of the authentication request, while issuing an own authentication to the content reception apparatus; an encryption section for generating key information based on information acquired by carrying out the authentication process in the authentication section to carry out an encryption process of the content to be transmitted to the content reception apparatus by the key information; a timer section (time measurement section) for transmitting the authentication request or a time confirmation request to the content reception section, and measuring the time until receiving a response to the request according to the necessity, or measuring the time until the arrival of a reception confirmation from the content reception apparatus, which is in response to the transmission of a response to the authentication request from the content reception apparatus, according to the necessity; and a device information management section for registering, managing and checking the device information of the content reception apparatus. In the content transmission apparatus, the device information management section is constructed to control the registry of the address information of the content reception apparatus and the device information specific to the apparatus, which is previously stored at the manufacturing time, in accordance with the measurement result of the timer section.

In the aspect, when the measurement result of the timer section does not exceed a predetermined value in the timer section, the address information and device specific information of the content reception apparatus may be registered to the device information management section.

In the aspect, upon reception of a content reception request from the content reception section, the address information and device specific information stored in the device information management section may be compared with the address information of the content reception apparatus and its device specific information, and when these are identical to each other, the content to the content reception section may be transmitted without implementing the time measurement by the timer section.

Further, in order to adequately manage registered information related to the content reception apparatus, the time measurement may be implemented periodically or at an arbitrary timing by the timer section relative to the content reception apparatus whose information was registered, and the registered information in accordance with the measurement results may be updated.

Also, in order to solve the above problem, another aspect of the present invention resides in a content reception apparatus for receiving content through a network, having: a network communications processing section for transmitting and receiving data through the network; a content reception processing section for receiving content to be received from a content transmission apparatus connected through the network, from the network communication section; an authentication section for issuing and transmitting an authentication request to the content transmission apparatus to determine the authentication of the authentication request from the content transmission apparatus; a decryption section for generating key information based on the information acquired by carrying out the authentication process in the authentication section to carry out an decryption process of the content received from the content transmission apparatus, by the key information; a timer section for measuring the time until the arrival of a reception confirmation from the content transmission apparatus, which is in response to the transmission of the authentication request to the content transmission apparatus or to the transmission of a response to the authentication request from the content transmission apparatus, or a section for requesting the content transmission apparatus to transmit a time confirmation request and responding to the time confirmation request transmitted from the content transmission section; and a device information management section for registering and managing the device information of the content transmission apparatus, wherein the device information management section is constructed to control the registry of the address information of the content transmission apparatus and its device specific information, which is previously stored at the manufacturing time, in accordance with the measurement result.

Further, in order to adequately manage the registered information related to the content transmission apparatus, it may be constructed to implement the time measurement periodically or at an arbitrary timing by the timer section relative to the content transmission apparatus where the information has been registered, thereby to update the registered information in accordance with the measurement results.

Further, it may be constructed that the content reception apparatus responds to the time confirmation request transmitted from the content transmission apparatus where the time until the arrival of the response is measured, and when the measurement result does not exceed a predetermined value, the address information of the own reception apparatus and its device specific information are registered to the content transmission apparatus, wherein the reception apparatus requests the content transmission apparatus to transmit a time confirmation request according to the necessity, while responding to the time confirmation request transmitted from the content transmission apparatus where the time until the arrival of the response is measured, thereby to update the registered information content in accordance with the measurement result.

In other words, in the aspects of the present invention, the content transmission apparatus and the content reception apparatus mutually authenticate before transmitting content, where the time until the arrival of a reception confirmation to the transmission of an authentication request or an authentication response is measured, and only in the case where the measured value does not exceed a certain maximum value, the content encrypted by the shared key data is transmitted and the address information and device specific information are registered, thereby to transmit the encrypted content without implementing the time measurement in the next content transmission. Further, the content of the address information and device specific information is reviewed periodically or at an arbitrary timing, so that the apparatus that is unconnected to the network or less frequently used does not remain registered. Thus, it makes it possible to implement copy protection to prevent unauthorized duplication of content in the content transmission using the wired or wireless LAN in the house, and also to limit the authorized viewing and duplication of content to the range of personal use.

According to the aspects of the invention, the reliability of the content transmission apparatus, reception apparatus and content transmission using the wired or wireless LAN in the house can be improved.

### BRIEF DESCRIPTION OF THE DRAWINGS

Embodiments of the present invention will be described in detail based on the following figures, wherein:

FIG. 1 is a view showing the configuration of a content transmission apparatus and content reception apparatus using a wired LAN, according to the invention;

FIG. 2 is a block diagram of the wired LAN made up of the content transmission apparatus and content reception apparatuses according to the invention;

FIG. 3 is a detailed view of a device information registry section of the content transmission apparatus according to the invention;

FIG. 4 is a view showing a list registered in the device information registry section of the content transmission apparatus according to the invention;

FIG. 5 is a view showing a procedure for transmitting content between the content transmission apparatus and the content reception apparatus according to the invention;

FIG. 6 is a view showing a procedure for carrying out a secure and accurate time authentication between the content transmission apparatus and the content reception apparatus according to the invention;

FIG. 7 is a view showing the configuration for content transmission/reception through the Internet among a content transmission apparatus and content reception apparatuses according to the invention;

FIG. 8 is a view showing the configuration of a content transmission apparatus and content reception apparatus using a wireless LAN, according to the invention;

FIG. 9 is a block diagram of the wireless LAN made up of the content transmission apparatus and content reception apparatuses according to the invention;

FIGS. 10A and 10B are views each showing a configuration example in a case of using a PDA according to the invention;

FIG. 11 is an example of a detailed view of the device information registry section in the content transmission apparatus according to the invention;

FIG. 12 is a view showing an example of a list registered to the device information registry section of the content transmission apparatus according to the invention;

FIG. 13 is an example of a procedure carried out in the content transmission apparatus side when authentication was achieved between the content transmission apparatus and content reception apparatus according to the invention;

FIG. 14 is an example of a procedure that the content transmission apparatus periodically implements time authentication;

FIG. 15 is an example of a procedure that the content transmission apparatus implements the time authentication when the power is input to the content transmission apparatus according to the invention;

FIG. 16 is an example of a procedure that the content transmission apparatus implements the time authentication when viewing reservation or recording reservation is made between the content transmission apparatus and content reception apparatus according to the invention;

FIG. 17 is an example of a procedure that the content reception apparatus requests the time authentication, according to the invention;

FIG. 18 is a view showing the configuration of a content transmission apparatus and content reception apparatus using the wired LAN and wireless LAN, according to the invention;

FIG. 19 is an example of a procedure that the content reception apparatus equipped with the wireless LAN and wired LAN implements the time authentication, according to the invention; and

FIG. 20 is an example of a procedure that the content reception apparatus equipped with the wireless LAN implements the time authentication, according to the invention.

### DESCRIPTION OF THE PREFERRED EMBODIMENTS

Hereinafter, embodiments of the invention will be described with reference to the drawings.

### Embodiment 1

Hereinafter, Embodiment 1 will be described.

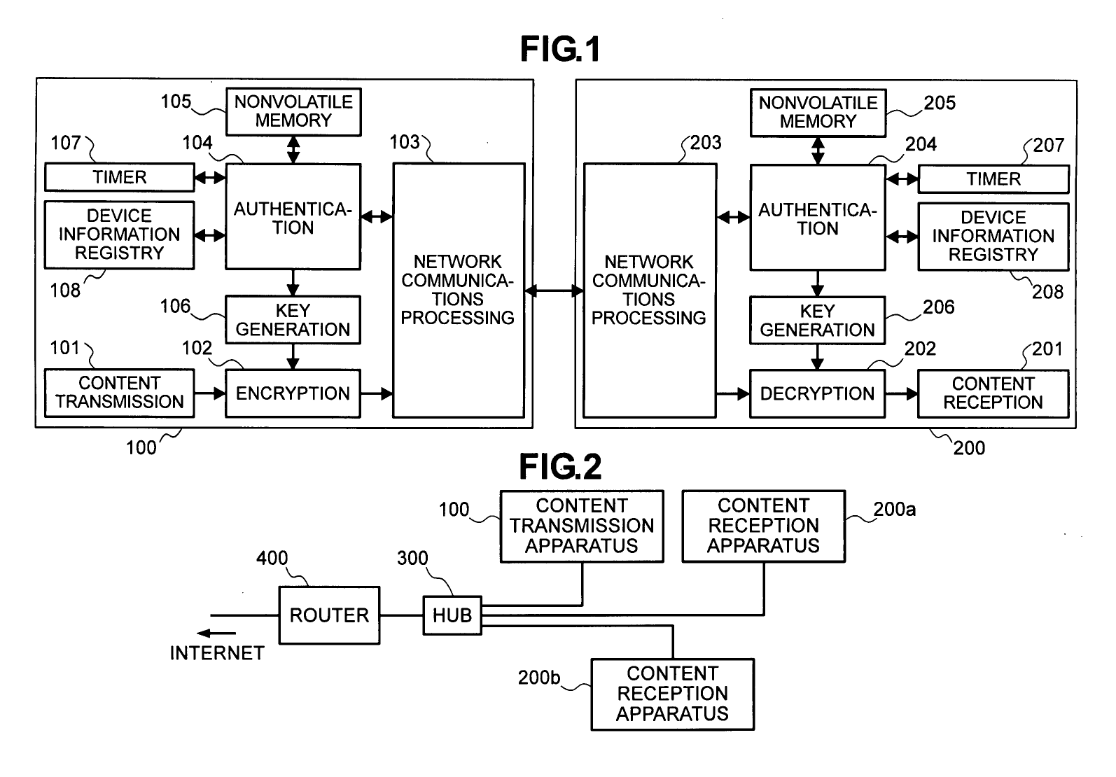

FIG. 1 shows the configuration of a content transmission apparatus 100 and content reception apparatus 200 according to an embodiment of the invention. The content transmission apparatus 100 and the content reception apparatus 200 are connected with each other through a LAN. In the content transmission apparatus 100, reference numeral 101 denotes a content transmission circuit for transmitting content to the content transmission apparatus 200, reference numeral 102 denotes an encryption circuit for encrypting the content the content transmission circuit 101 outputs, reference numeral 103 denotes a network communications processing circuit for exchanging an output of the encryption circuit 102 and an input/output of an authentication circuit 104 with another apparatus through the LAN, reference numeral 104 denotes the authentication circuit for exchanging information with another apparatus connected on the LAN to implement mutual authentication between the apparatuses, reference numeral 105 denotes a nonvolatile memory for storing information necessary for the process in the authentication circuit 104, reference numeral 106 denotes a key generation circuit for generating key information necessary for the content encryption in the encryption circuit 102 based on the information of the authentication circuit 104, reference numeral 101 denotes a timer circuit for measuring the time from the transmission of information such as an authentication request the authentication circuit 104 generates to the arrival of a reception confirmation to the information, reference numeral 108 denotes a device information registry section for registering and managing the device information of another apparatus authenticated in the authentication circuit 104. The content is appended with an identification code indicating how to treat it, such as “Copy free”, “Copy one generation”, “No more copies”, or “Copy never”, and is transmitted to the content reception apparatus.

In the content reception apparatus 200, reference numeral 201 denotes a content reception circuit for receiving content transmitted through the LAN, reference numeral 202 denotes a multiplex circuit for receiving the content encrypted in the encryption circuit 102 of the content transmission circuit 100, from the network communications processing circuit 203 and multiplexing the encrypted content to output to the content reception circuit 201, reference numeral 203 denotes the network communications processing circuit for exchanging an input to the multiplex circuit 202 and an input/output of an authentication circuit 204 with another apparatus through the network, reference numeral 204 denotes the authentication circuit for exchanging information with another apparatus to implement mutual authentication between the apparatuses, reference numeral 205 denotes a nonvolatile memory for storing information necessary for the process in the authentication circuit 204, reference numeral 206 denotes a key generation circuit for generating a key necessary for the content multiplex in the multiplex circuit 204, reference numeral 207 denotes a timer circuit for measuring the time from the transmission of information such as an authentication request to another apparatus to the arrival of a reception confirmation to the information, reference numeral 208 is a device information registry section for registering and managing the device information of another apparatus authenticated in the authentication circuit 204. The received content is processed in accordance with the identification code transmitted along with the relevant content, “Copy free”, “Copy one generation”, “No more copies”, or “Copy never”. The content of “Copy free”or “Copy one generation” can be recorded on a content recording medium. When the content of “Copy one generation” is recorded, subsequently the relevant content is treated as “No more copies”.

FIG. 2 shows a configuration example of a LAN installed in a house, including the content transmission apparatus 100 and the content reception apparatus 200. One content transmission apparatus 100 and two content reception apparatuses 200a, 200b are respectively connected to a network hub device 300 with a cable of a wired LAN. The network hub device 300 is connected to a router 400. The router 400 is connected to the Internet through a modem or a photoelectric converter and the like. The content transmission apparatus 100, the content reception apparatuses 200a, 200b, and the router 400 have IP addresses that identify themselves on the LAN, respectively. Each interface section of the network communications processing circuits is previously provided with 48-bits MAC (Media Access Control) address at the manufacturing time. IP addresses are configured to each of the apparatuses with a DHCP (Dynamic Host Configuration Protocol) that has been widely adopted for automatically configuring addresses in a network in the past. For example, the router 400 is operated as a DHCP server from which the IP addresses of each apparatuses are assigned. Incidentally, in the case of using an IPv6 (Internet Protocol Version 6), each apparatus can also define its own IP address by the top 64 bits of the IP address of the router 400 and the MAC address, based on a method called stateless automatic configuration.

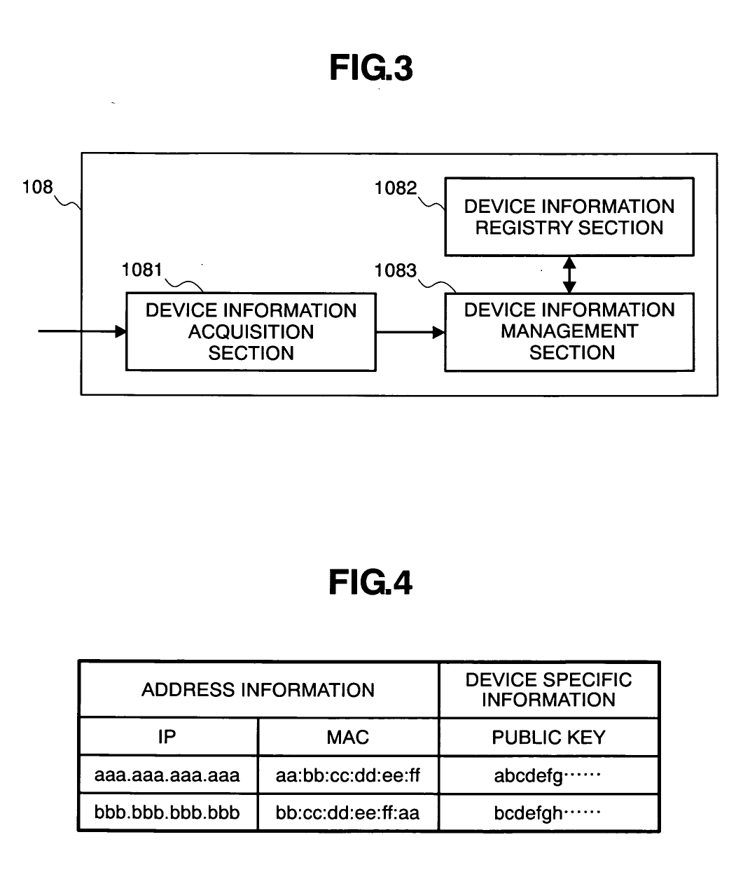

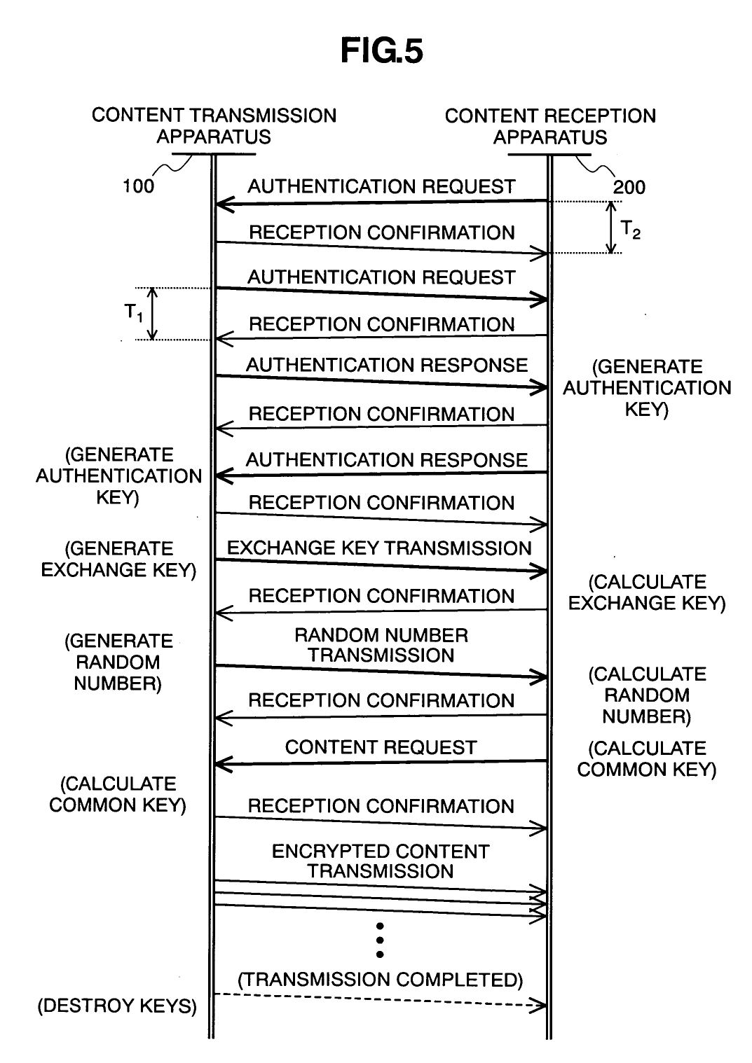

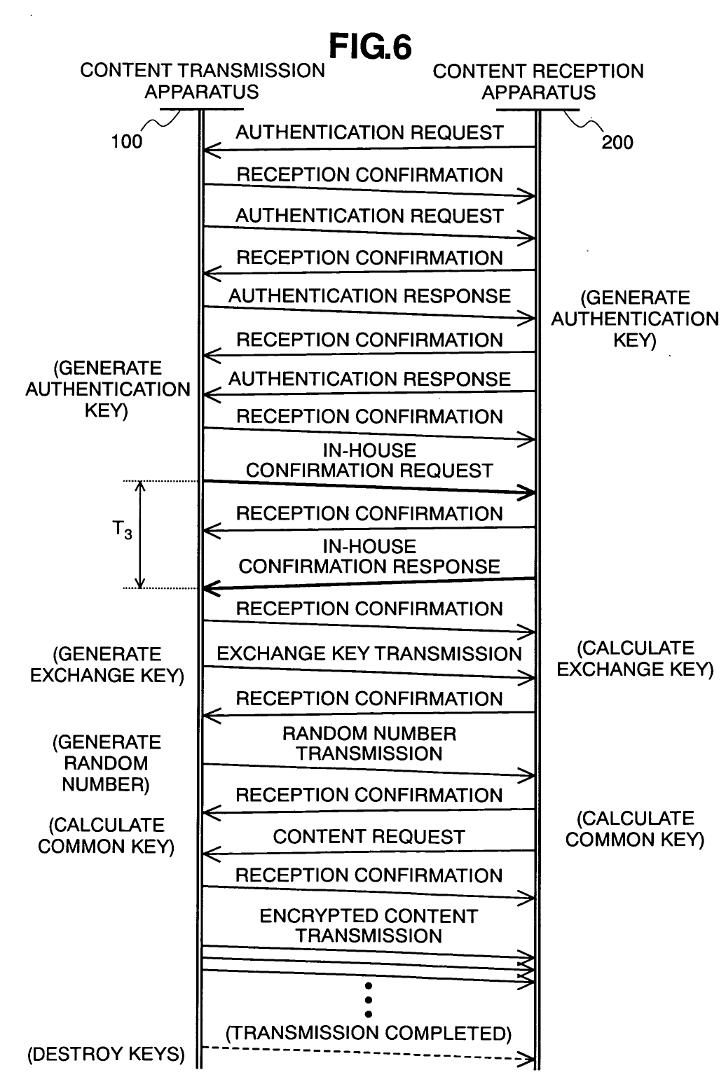

FIG. 3 is a view showing the configuration of a device information registry section 108 the content transmission apparatus 100 holes. The description will be made on an example of a registry method of the address information and device specific information of the content reception apparatus 200, for example, in the case where the content reception apparatus 200 is connected to the network to which the content transmission apparatus 100 is connected. Reference numeral 1081 denotes a device information acquisition section for acquiring address information and device specific information from the content reception apparatus 200, reference numeral 1082 denotes a device information registry section for registering the address information and device specific information of the content reception apparatus 200 acquired in the device information acquisition section 1081, and reference numeral 1083 denotes a device information management section for authenticating the content reception apparatus 200 from the registry of the content reception apparatus and the device information registered in the device information registry section 1082. The device information acquisition section 1081 transmits, for example, a device information registry application or a registry Webpage using a browser, to the content reception apparatus 200. Upon reception of the device information registry application or the registry Webpage, the content reception apparatus 200 registers the own address information and device specific information to the content transmission apparatus 100 through the input of registry items by itself or by a user, in accordance with the application or web page for the device information registry. The device specific information referred herein is, for example, a public key generated by a specific certification body and stored in the nonvolatile memory 205 of the content reception apparatus 200. The public key is a public key previously stored in the nonvolatile memory 205 in the manufacturing process of the content reception apparatus 200, having a unique value for each apparatus. FIG. 4 is an example of the device information stored in the device information registry section 1082. The IP address and MAC address are registered as the address information of the content reception apparatus 200, and the public key stored in the nonvolatile memory 205 of the content reception apparatus 200 is registered as the device specific information.

Thus, the content transmission apparatus 100 can identify the registered content reception apparatus 200 based on the device information stored in the device information registry section 108 for authenticating the content reception apparatus 200.

Herein, as an example of the device specific information, the description is made taking the public key which is used in the mutual authentication, when the DTCP where the copy protection method is defined is used in the content transmission between the content transmission apparatus and the content reception apparatus each connected through the network. However, the device specific information is not specifically limited to the public key, and any unique information capable of identifying the apparatus may be registered.

Further, in Embodiment 1, the description has been made on the method that the content transmission apparatus 100 registers the device information of the content reception apparatus 200. Also, a method that the content reception apparatus 200 registers the content transmission apparatus 100 is the same as described above.

### Embodiment 2

Next, Embodiment 2 of the invention will be described:

According to the embodiment, it is possible to provide a content transmission apparatus and reception apparatus capable of implementing copy protection to prevent unauthorized duplication of content in the course of content transmission using a wired or wireless LAN as well as limiting the authorized viewing and duplication of content to the range of personal use.

FIG. 5 shows an example of a procedure for the content transmission/reception by the content transmission apparatus 100 and the content reception apparatus 200. The left side represents the content transmission apparatus 100 and the right side represents the content reception apparatus 200, where the arrows indicate the timing and direction of the transmission/reception of information between the two sides.

First, an authentication request is generated from the side of the content reception apparatus 200. The authentication request is transmitted along with the public key specific to the apparatus and a certificate of the public key, to the content transmission apparatus 100. Upon reception of the authentication request, the content transmission apparatus 100 transmits a reception confirmation thereof to the content reception apparatus 200, generates an authentication request from the own side, and similarly to the case of the content reception apparatus, transmits the authentication request to the content reception apparatus. 200, along with the public key specific to the content transmission apparatus 100 and its certificate that the certification body issued. Then the transmission apparatus starts the timer circuit 107 to measure a time T1 until the reception confirmation to the authentication request is received by the content reception apparatus 200. When the measured value in the timer circuit 107 does not exceed a predetermined value (T), namely T1<T, the content transmission apparatus 100 authenticates the content reception apparatus 200 as the apparatus in the range of personal use (hereinafter, referred to as time authentication).

At this time, it is also possible to implement the time authentication, when the authentication request is transmitted from the side of the content reception apparatus 200 to the content transmission apparatus 100, by starting the timer circuit 207 to measure a time T2 until the reception confirmation from the content transmission apparatus 100 is received. As described above, when the authentication is mutually achieved, an authentication key common to each other is created and shared. The authentication key may be generated using a well known key exchange algorithm. Upon completion of sharing the authentication key, the content transmission apparatus 100 generates an exchange key and a random number, encrypts the exchange key and the random number by the authentication key respectively, and transmits them to the content reception apparatus 200.

Incidentally, in FIG. 5, the exchange key and the random number are separately transmitted from the content transmission apparatus 100 to the content reception apparatus 200, but they may be transmitted all together. The content reception apparatus 200 decrypts the exchange key transmitted from the content transmission apparatus 100 using the authentication key, and holds the decrypted exchange key together with the random number that is received and decrypted in the same manner. Next, a common key is generated based on a predetermined mathematical algorithm using the exchange key and the random number in the respective sides of the content transmission apparatus 100 and the content reception apparatus 200. With the common key obtained as described above, the content transmission apparatus 100 can encrypt and transmit content, while the content reception apparatus 200 can receive decrypted content.

When the authentication was achieved between the content transmission apparatus 100 and the content reception apparatus 200, it is constructed that the content reception apparatus 200 transmits a content transmission request to the content transmission apparatus 100, which triggers the content transmission apparatus 100 to transmit the encrypted content. Upon completion of necessary content transmissions, the content transmission apparatus 100 destroys the authentication key, the exchange key, and the common key that is necessary for the encryption and decryption of the content. Similarly, the content reception apparatus 200 destroys the authentication key, the exchange key, and the common key, and may be start again from the authentication request for trying to receive content again. However, according to the embodiment of the invention, when the content reception apparatus 100 received the time authentication, the address information and device specific information of the content reception apparatus 200 are registered in the device information registry section 108 of the content transmission apparatus 100 as described above. Thus, the content transmission apparatus 100 and the content reception apparatus 200 keep the common key, instead of destroying it, for the content reception apparatus 200 registered in the device information registry section 108 of the content transmission apparatus 100, so that it is not necessary to start from the authentication request for carrying out another content reception.

FIG. 6 shows an example that the time can be measured more securely and accurately in the time authentication. As shown in FIG. 6, the mutual authentication is achieved between the content transmission apparatus 100 and the content reception apparatus 200, and the content transmission apparatus 100 transmits an in-house confirmation request to the content reception apparatus 200 while starting the timer circuit 107. The content reception apparatus 200 transmits a reception confirmation to the in-house confirmation request from the content transmission apparatus 100, and then transmits an in-house confirmation response. The content transmission apparatus 100 measures a time T3 until the reception of the in-house confirmation response from the content reception apparatus 200, and authenticates as the reception apparatus present in the house when the time T3 does not exceed a predetermined value. As described above, the content transmission apparatus 100 and the content reception apparatus 200 each authenticate between the apparatuses and implement the time authentication after the mutual authentication, which makes it possible to implement more secure and accurate time authentication.

The protocol used for transmitting content from the content transmission apparatus 100 to the content reception apparatus 200 is not limited to a specific one, and any protocol such as RTP (Real-time Transport Protocol), HTTP (Hyper Text Transfer Protocol), or FTP (File Transfer Protocol) can be used. Upon content transmission, the content is encrypted by a predetermined algorithm using the common key and the encrypted content is accommodated in the payload part in each transmission protocol, and then transmitted therefrom. As the encryption algorithm, for example, AES (Advanced Encryption Standard) which is a well known encryption technology may be used.

As described above, in the second embodiment of the invention, the content transmission apparatus registers the address information and device specific information of the content reception apparatus once received the time authentication, so that it is possible to transmit encrypted content without implementing the time authentication of the content reception apparatus for receiving content again. Thus, the time authentication having been implemented for each reception of content can be omitted.

### Embodiment 3

Hereinafter, Embodiment 3 will be described.

According to Embodiment 3 of the invention, it is possible to view content from the content transmission apparatus 100 through the Internet, for example, by a mobile terminal.

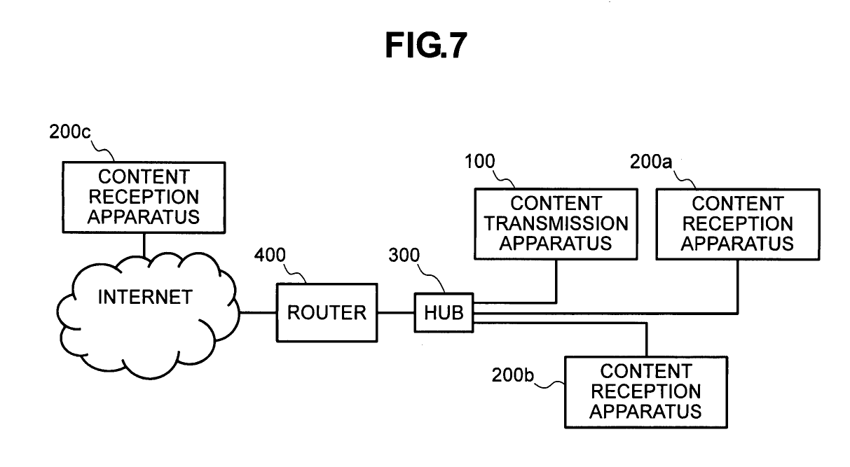

FIG. 7 is a configuration view when content is viewed through the Internet. Reference numeral 200c denotes a portable content reception apparatus to which the content transmission apparatus has once applied the time authentication. Under normal circumstances, the portable content reception apparatus 200c connected to the Internet is not authenticated due to the time authentication result with the content transmission apparatus 100 as T1>T, thereby the reception apparatus can not receive the content transmitted from the content transmission apparatus 100. However, according to the invention, the content transmission apparatus 100 once succeeded in the time authentication to the portable content reception apparatus 200c, and registers the address information of the portable content reception apparatus 200c and the public key specific to the apparatus, to the device information registry section 108. Thus, the portable content reception apparatus 200c registered in the device information registry section 108 can receive content transmitted from the content transmission apparatus 100, without being subjected to the time authentication, even in the case where the time authentication would result in T1>T.

Further, only the apparatus registered in the device information registry section 108 can receive to view the content transmitted from the content transmission apparatus 100, which makes it possible to implement copy protection to prevent unauthorized duplication of content and also to limit the unauthorized viewing and duplication of content to the range of personal use.

In addition, when transmitting a TCP packet in the transmission of the authentication request and the authentication response to the result thereof as well as when carrying out the content transmission, an IP packet encapsulating the TCP packet or an UDP datagram is transmitted by dropping the TTL (Time To Live) of the IP packet down to a low value of 1 so that the authentication request will not pass through the router 400, which also makes it possible to place a restriction on the content transmission not to exceed the range of personal use.

### Embodiment 4

Hereinafter Embodiment 4 will be described.

The fourth embodiment carries out content transmission between a content transmission apparatus 500 and a content reception apparatus 600 using a wireless LAN.

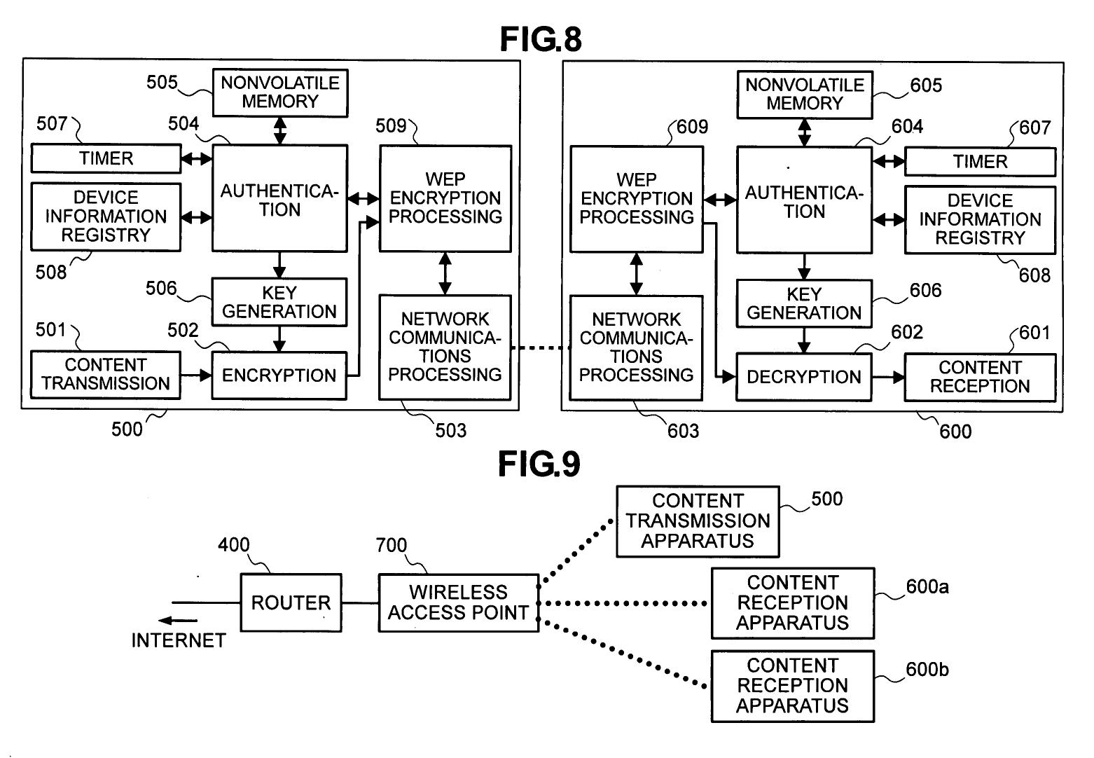

FIG. 8 shows the content transmission and reception apparatuses through the wireless LAN, which use a wireless network communications processing circuits 503 and 603 for the connection with the LAN, including WEP (Wired Equivalent Privacy) encryption processing circuits 509 and 609, respectively. The WEP is a known standard encryption system used for the purpose of security protection in the wireless LAN. The system can realize communication with the security protection applied thereto, between the transmission apparatus and the reception apparatus under the user's control.

FIG. 9 shows an example of the configuration of a network installed in a house, using the content transmission apparatus 500 and the content reception apparatus 600. In FIG. 9, the data transmission apparatus 500 and two data reception apparatuses 600a, 600b are connected with a wireless access point 700 by the wireless LAN. The wireless LAN access point 700 is further connected to the router 400 which is connected to the Internet in the same manner as the router 400 shown in FIG. 2.

In order to implement mutual authentication and the following content transmission between the content transmission apparatus 500 and content reception apparatus 600 shown in FIG. 8, authentication circuits. 504 and 604 check whether the WEP process has been applied in WEP encryption processing circuits 509 and 609. When the WEP process has not been applied, the mutual authentication and the following content transmission may not be carried out, or a necessary process may be carried out, such as a display for prompting the user to activate the WEP process. In this way, the content transmission using the wireless LAN is always carried out in the state where the WEP process was applied. As a result, it is possible to prevent a situation where another data reception apparatus is connected through the wireless LAN and the content is illegally copied beyond the awareness of the users of the content transmission apparatus 500 and the content reception apparatus 600.

Other aspects than those described above are exactly the same as the content transmission method carried out by the content transmission apparatus and content reception apparatus that have been described in the first to third embodiments. That is, it is possible to protect copyright by suppressing unauthorized duplication of content, while preventing the content transmission from being carried out beyond the range of personal use.

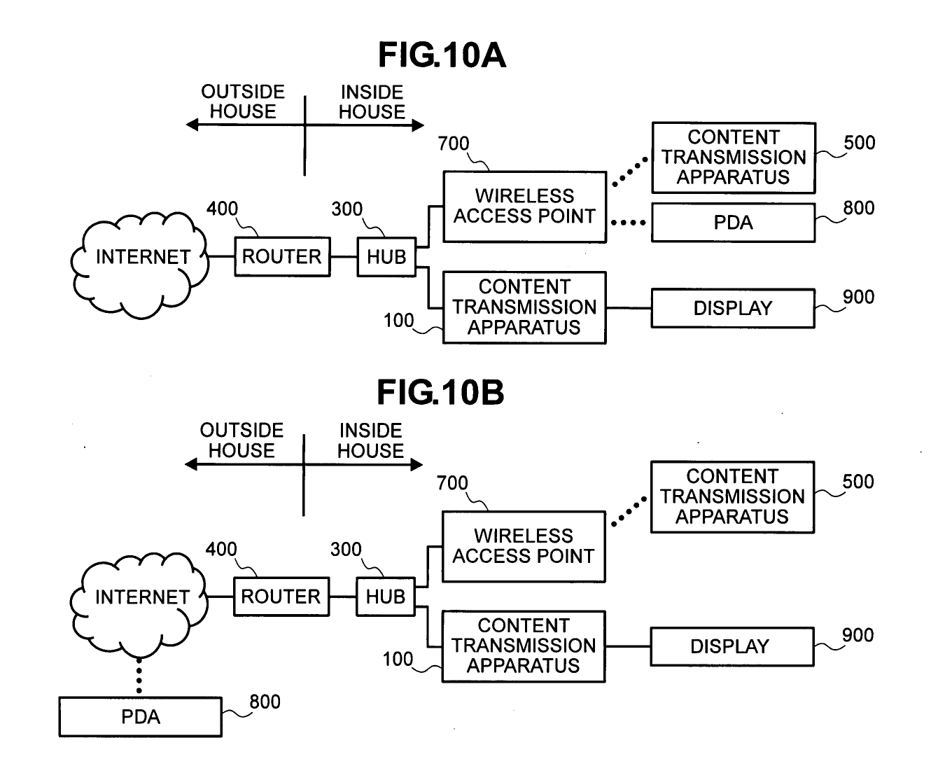

FIGS. 10A and 10B are views each showing an example of a case where, for example, a PDA (Personal Digital Assistance) is used in the embodiment of the invention. FIG. 10A shows a connection for the authentication between the content transmission apparatuses 100 and 500. FIG. 10B is a view showing a case where the content of the content transmission apparatuses 100, 500 installed in the house, is viewed from outside. Reference numeral 800 denotes a PDA allowing the content delivered from the content transmission apparatuses 100, 500 to be viewed. Reference numeral 900 denotes a display allowing the content delivered from the content transmission apparatuses 100, 500 to be viewed, such as, for example, a plasma display or a liquid crystal display.

For example, it is assumed that a purchased PDA (800) is connected inside the house, subjected to the time authentication between with the content transmission apparatuses 100, 500, and is authenticated in the respective sides. In the past, the content transmission apparatuses 100 and 500 have managed the receiving equipment by registering the common key which is the address information of the PDA (800) and the device specific information used in the time authentication, so that the PDA (800) outside the house has not been authorized to receive the content delivered from the content transmission apparatuses 100, 500 installed in the house due to the time authentication. However, according to the invention, the PDA was once received the time authentication by the content transmission apparatuses 100, 500 and the device information was registered, so that it is possible to view the content delivered from the content transmission apparatuses 100, 500 installed in the house with the PDA (800) from outside.

### Embodiment 5

Hereinafter, Embodiment 5 will be described.

In Embodiment 5 of the invention, the description will be made on a method that checks the content of the address information and device information registered in the device information registry section 108 of the content transmission apparatus 100 to always update to the information content appropriate for the latest network configuration.

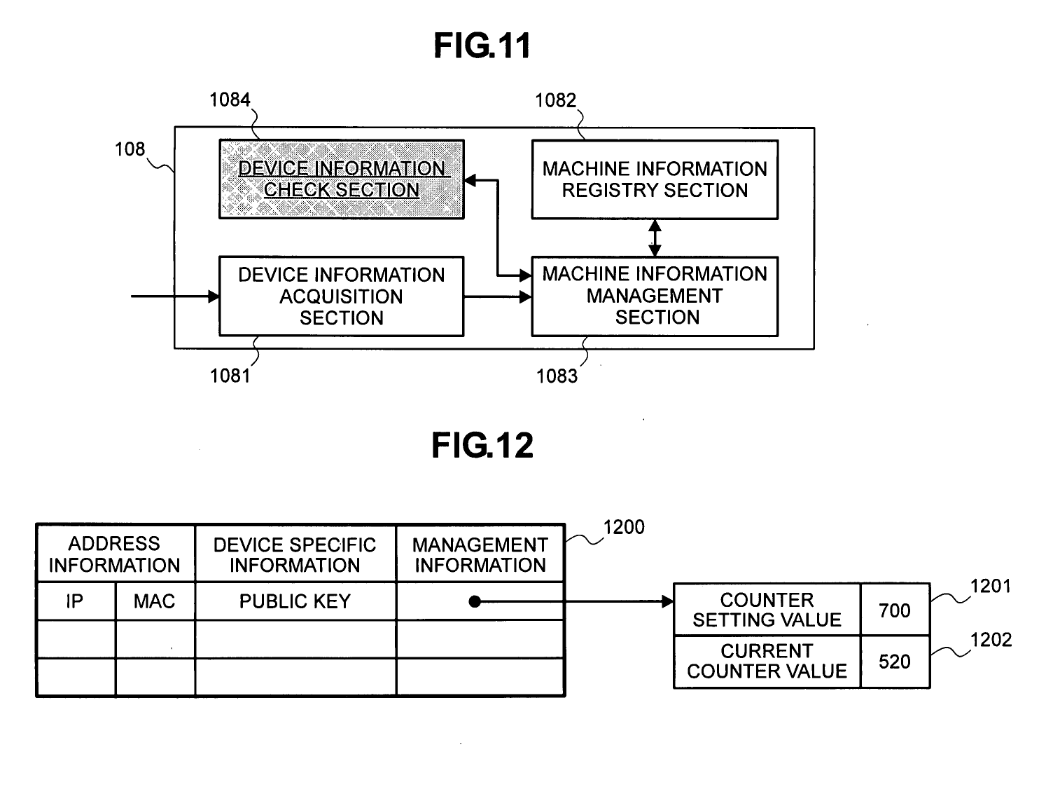

FIG. 11 is a view showing the configuration of the device information registry section 108 the content transmission apparatus 100 holds.

The device information acquisition section 1081, the device information registry section 1082, and the device information management section 1083 are the same as those described above.

A device information check section 1084 implements the time authentication using the timer circuit 107 in order to check the information registered in the device information registry section 1082, and instructs the device information management section 1083 to update the content of the registered information in accordance with the measurement results.

FIG. 12 is a view showing an example of management data for the device information check section 1084 to update the information registered in the device information registry section 1082.

The device information registry section 1082 also holds management information 1200 such as a counter setting value 1201 and a current counter value 1202 for each content reception apparatus 200, in addition to the registered address information and device specific information related to the content reception apparatus 200.

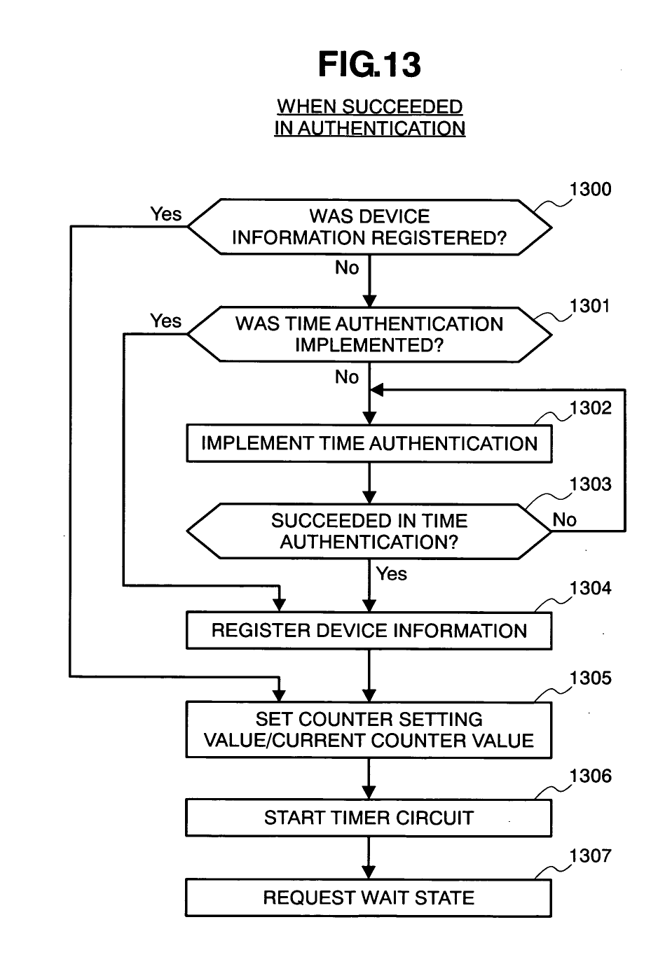

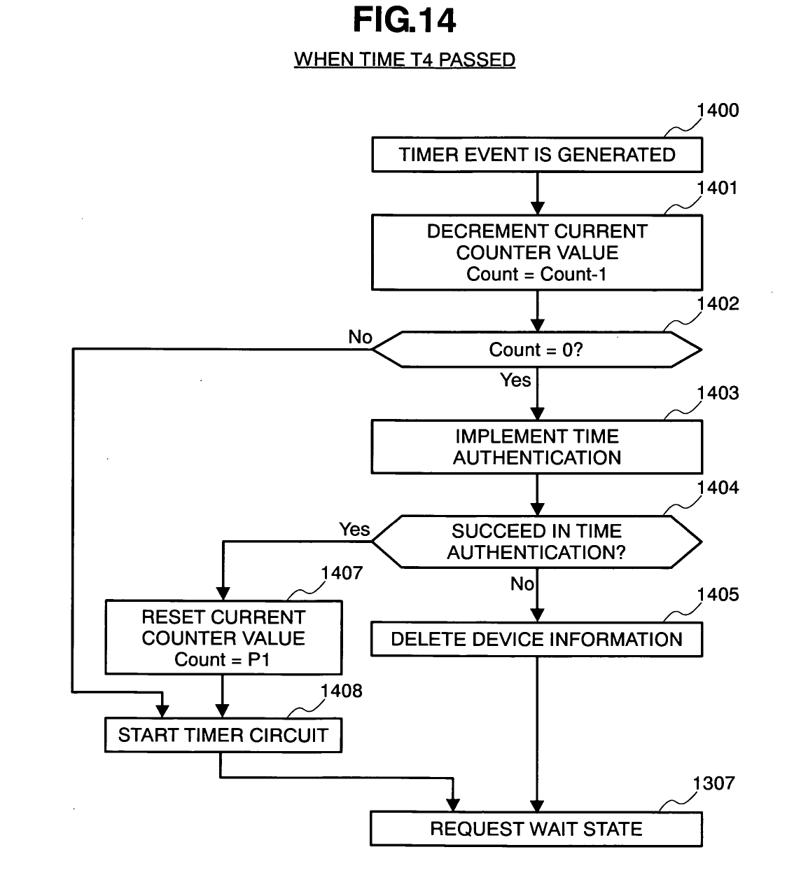

Next, a method that the device information check section 1084 checks the information registered in the device information registry section 1082 will be described using FIGS. 13 and 14.

FIG. 13 shows an example of a procedure carried out in the side of the content transmission apparatus 100 when the authentication is achieved between the content transmission apparatus 100 and the content reception apparatus 200.

When the authentication is achieved with the content reception apparatus 200, the content transmission apparatus 100 searches whether there is any information identical to the address information and device specific information of the relevant content reception apparatus 200 of all the address information and device specific information registered in the device information registry section 108 (Step 1300). As a result, when none is identical, the content transmission apparatus 100 determines whether the time authentication was implemented during the authentication (Step 1301), and when not implemented, implements the time authentication using the timer circuit 107 (Step 1302). Then, the content transmission apparatus 100 determines the result of the time authentication (Step 1303), and when succeeded, registers the address information and device specific information of the relevant content reception apparatus 200 to the device information registry section 108 (Step 1304).

Subsequently, the device information check section 1084 within the device information registry section 108 generates the management information 1200 related to the registered information, and sets a predetermined value (Pi) to the counter setting value 1201 (CountMax) and to the current counter value 1202 (Count). Then, the check section starts and sets the timer circuit 107 so as to provide event notification every time a predetermined time (T4) has passed (Step 1306), and goes into a state waiting for communication and authentication requests from the apparatuses on the network (Step 1307).

Herein, when failed in the authentication in Step 1303, the device information check section 1084 retries the time authentication if necessary. When further failed in the authentication, the check section puts the apparatus into a state of not transmitting the content to the content reception apparatus 200, and ends the process.

Further, when the content reception apparatus 200 is already registered in Step 1300, the device information check section 1084 moves to the process of Step 1305. Alternatively, when the check section refers to the counter setting value 1201 (CountMax) and current counter value 1202 within the management information 1200 to confirm Count<CountMax, and when the timer circuit 107 is already running, the check section may move to the process of Step 1307.

Further, the predetermined value (P1) that is set to the counter setting value 1201 (CountMax) in Step 1305 may be a value common to all the content reception apparatuses, or may vary for each content reception apparatus.

Next, FIG. 14 shows an example of a procedure carried out in the side of the content transmission apparatus 100, when an event notification is generated by the timer circuit 107 after the predetermined time (T4) in the communication wait state in the above Step 1307.

First, the timer circuit 107 generates a timer event when the time T4 has passed, and notifies the content transmission apparatus 100 (Step 1400). Upon reception of the notification, the device information check section 1084 decrements the value of the current counter value 1202 (Count) (Step 1401), and determines whether the value is Count=0 (Step 1402).

As a result, when the value is Count=0, at this time, there may be a way to destroy the information related to the content reception apparatus 200 registered in the device information registry section 108, and if necessary, destroying the authentication key, the exchange key, and the common key as well. However, in the embodiment of the invention, the device information check section 1084 implements again the time authentication with the content reception apparatus 200 using the timer circuit 107 (Step 1403). Then, the check section determines the result of the time authentication (Step 1404), and when succeeded, sets the value of the counter setting value 1201 to the current counter value 1202 (Count=CountMax) within the management information 1200 (Step 1407), starts the timer circuit 107 in the same manner as described above (Step 1408), and goes into the wait state (Step 1307). On the other hand, when failed in the time authentication in Step 1404, the check section retries the time authentication if necessary. When further failed in the time authentication, the check section requests the device information management section 1083 to delete the information related to the content reception apparatus 200, and if necessary, destroying the authentication key, the exchange key and the common key as well (Step 1405). Finally, it goes into the wait state (Step 1307).

On the other hand, when it is determined as Count>0 in Step 1402, the check section starts again the timer circuit 107 to set so as to provide the event notification every time the predetermined time (T4) has passed (Step 1408), and returns to the wait state (Step 1307).

Herein, the above description has been made such that after registering the information related to the content reception apparatus 200 to the device information registry section 108, the device information check section 1084 implements the time authentication every time the predetermined time (T4×CountMax) has passed, using the predetermined time (T4) as a timing for decrementing the current counter setting value 1202. However, it is also possible to measure the time when the content is not being transmitted (or is being transmitted) and to implement the time authentication when the accumulated value reaches to a certain time (T5).

Further, in the above description, the time (T4/T5) is used as the timing of updating the counter setting value. However, it is also possible to use a predetermined number of packets of the content transmitted to the content reception apparatus 200, or a predetermined number of updates of the common key used in the content transmission.

Further, it is possible that after registering the information related to the content reception apparatus 200 to the device information registry section 108, the device information check section 1084 always monitors whether the relevant content reception apparatus 200 is present on the network, and upon detecting its absence, sets the counter setting value 1201 and the current counter setting value 1202, starts the timer circuit 107 to periodically measure the time thereby to update the current counter setting value 1202, and if the time when the content reception apparatus 200 is absent on the network reaches to a predetermined time, the device information check section deletes the information related to the content reception apparatus 200 from the device information registry section 108, and if necessary, destroying the authentication key, exchange key, and common key as well. The method of monitoring whether the apparatus is present on the network is not limited to a specific one, and any function such as a keep-alive function the TCP provides can be used.

Further, it is possible to cause the device information check section 1084 to have a plurality of counters (CountMax 1, Count 1, CountMax 2, Count 2) to provide several combinations of timing for implementing the time authentication. For example, it is thought that the check section decrements the current counter setting value Count 1 for each of the time (T4) while decrementing the current counter setting value Count 2 for each of the number of transmitted packets (P1), and then implements the time authentication when either of the two values reaches to the predetermined value (CountMax 1 or CountMax 2).

Herein, the description has been made on the content transmission apparatus 100, which can be similarly applied to the content transmission apparatus 500 and the content reception apparatuses 200, 600.

Further, the procedure for implementing the time authentication in Steps 1302 and 1403 can be realized by implementing the time measurement (1) using the authentication request described above with reference to FIG. 5 and/or the time measurement (2) using the in-house confirmation request described above with reference to FIG. 6.

Thus, the device information check section 1804 of the content transmission apparatus periodically implements the time authentication of the information related to the content reception apparatus 200 registered in the device information registry section 108, so that it is possible to prevent the registered information related to the apparatus unconnected or less frequently used, from remaining registered in the device information registry section 108, allowing an adequate management of the registered information depending on the network configuration.

### Embodiment 6

Hereinafter, Embodiment 6 will be described.

In the Embodiment 5, the description has been made on the method that the device information check section 1084 of the content transmission apparatus 100 periodically implements the time authentication to the content reception apparatus 200 registered in the device information registry section 108. In embodiment 6 of the invention, the description will be made on a method that the content transmission apparatus 100 implements the time authentication at an arbitrary timing at necessary time.

Herein, the necessary time is, for example, a case where the power supply or network of the content transmission apparatus 100 is disconnected or goes into a standby state and subsequently the power is input again or the network is connected again. Also, it may be a case where a process is carried out between the content transmission apparatus 100 and the content reception apparatus 200, such as making a reservation for viewing or recording the content, which is the process that the content transmission should not be interrupted during execution.

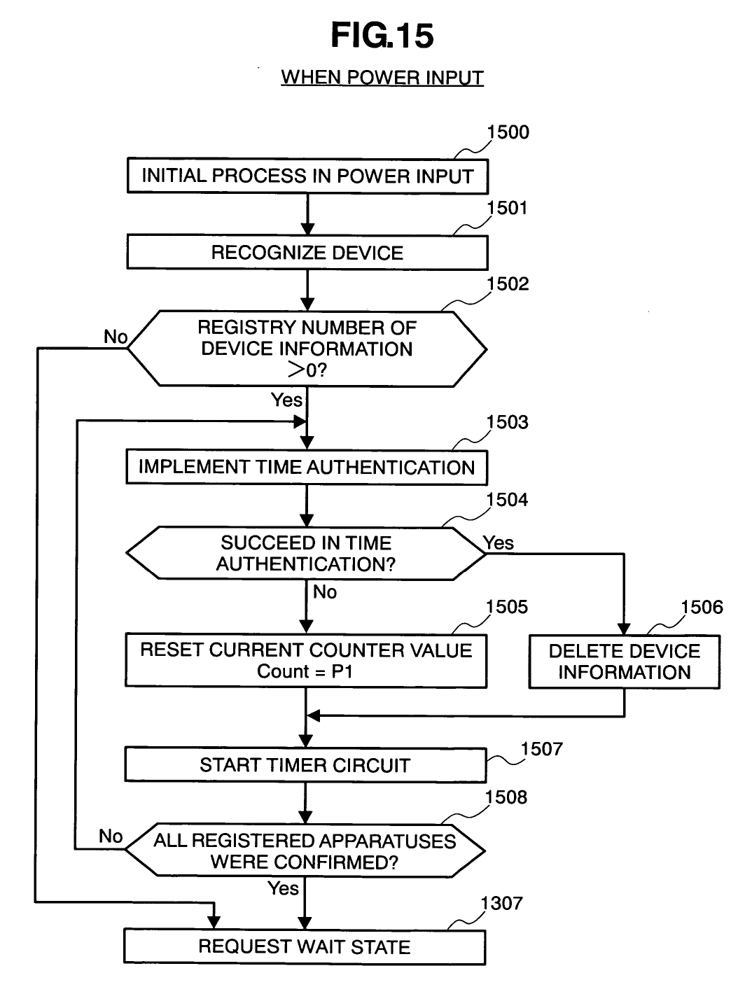

FIG. 15 shows an example of a series of processing steps executed in the side of the content transmission apparatus 100, when the power supply of the content transmission apparatus 100 is disconnected or goes into a standby state and subsequently the power is input again.

First, the content transmission apparatus 100 carries out the system setting and initialization process necessary in the power input (Step 1500), and detects apparatus present on the network (Step 1501). The method of detecting apparatus is not limited to a specific one, and any function such as UPnP (Universal Plug and Play) or Jini can be used.

Next, the content transmission apparatus 100 determines whether address information and device specific information are registered in the device information registry section 108 (Step 1502). When the information related to one or more content reception apparatuses 200 is registered, the content transmission apparatus 100 implements the time authentication to each of the content reception apparatuses 200 using the timer circuit 107 (Step 1503). Then, the content transmission apparatus 100 determines the result of the time authentication (Step 1504), and when succeeded, sets the value of the counter setting value 1201 to the current counter value 1202 (Count=CountMax) within the management information 1200 that the device information check section 1804 manages (Step 1505), and starts the timer circuit 107 in the same manner as described above (Step 1507).

On the other hand, when failed in Step 1504, the content transmission apparatus 100 retries the time authentication if necessary. When further failed, the transmission apparatus deletes the registered information related to the relevant content reception apparatus 200 within the device information registry section 108 (Step 1506).

When the time authentication to all the registered content reception apparatuses 200 has been completed (Step 1508), the transmission apparatus 100 goes into a state waiting for communication and authentication requests from the apparatuses on the network (Step 1307).

Herein, in Steps 1501 and 1502, it is also possible to compare the apparatuses currently present on the network with the address information and device specific information registered in the device information registry section 108, and at this time, delete the address information and device specific information related to the apparatus absent on the network but its address information and device specific information are present.

Further, in Steps 1505 and 1506, although the timer circuit 107 is started after the success of the time authentication, it may be started after Step 1508.

Thus, when the power supply or network of the content transmission apparatus 100 is disconnected or goes into a standby state and subsequently the power is input again or the network is connected again, it is possible to update the registered information to the content with the latest network configuration in mind, by implementing the time authentication to the registered content reception apparatuses 200.

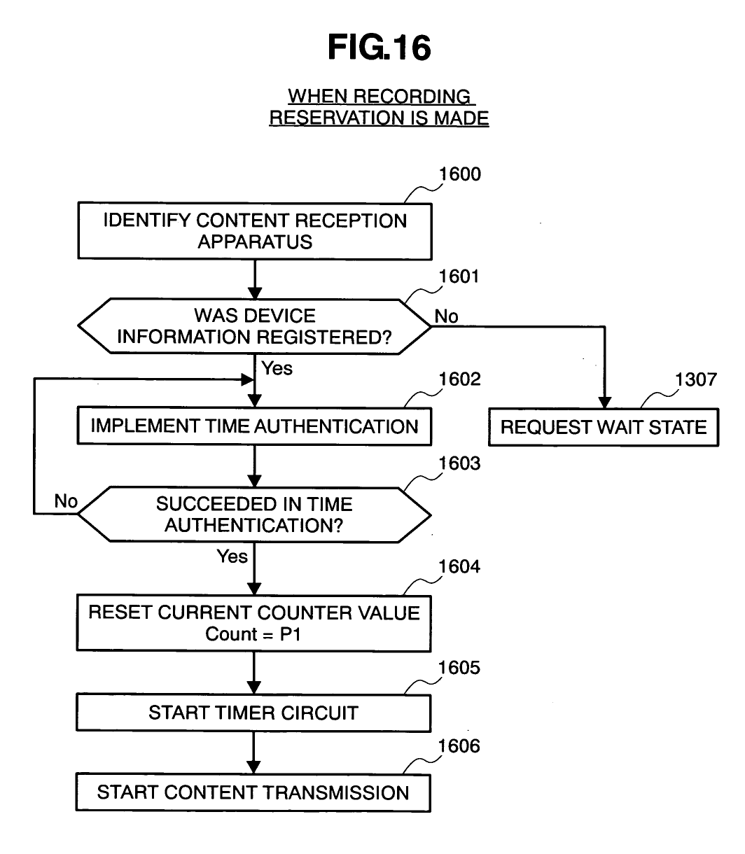

Next, FIG. 16 shows an example of a procedure carried out in the side of the content transmission apparatus 100, when a reservation is made in the content reception apparatus 200 for recording the content to be transmitted by the content transmission apparatus 100.

First, before starting the recording reservation, the content transmission apparatus 100 identifies the content reception apparatus 200 which is the content transmission destination (Step 1600), and determines whether the address information and device specific information of the relevant content reception apparatus 200 are registered in the device information registry section 108 (Step 1601). As a result, when the information is already registered, the content transmission apparatus 100 implements the time authentication to the content reception apparatus 200 using the timer circuit 107 (Step 1602), and determines the result (Step 1603). When succeeded in the time authentication, the transmission apparatus sets the value of the count setting value 1201 to the current counter value 1202 (Count=CountMax) within the management information 1200 that the device information check section manages (Step 1604), and starts the timer circuit 107 in the same manner as described above (Step 1605). Subsequently, upon reception of a content request from the content reception apparatus 200, the transmission apparatus starts transmitting the content (Step 1606).

Herein, in Step 1601, when the relevant content reception apparatus 200 is not registered, the content transmission apparatus 100 goes into the state waiting for an authentication request from the content reception apparatus 200 (Step 1307). Herein, the series of steps can be also applied, in addition to the viewing reservation and recording reservation, to the case where the type of the content that the content transmission apparatus 100 is transmitting varies (for example, when the broadcast program is switched, the channel is selected, or the accumulated program is changed). Further, it is possible to carry out the same steps in the case where the content transmission apparatus 100 always monitors the operation state of the content reception apparatus 200, and detects again the presence of the content reception apparatus 200 where the power supply or network once disconnected, or detects a recording state.

Thus, the content transmission apparatus 100 implements the time authentication with the content reception apparatus 200 before making a reservation for viewing or recording the content, and returns the current counter value 1202 (Count) to the counter setting value (CountMax), so that it is possible to prevent as much as possible the time authentication from running during the viewing or recording reservation operation, and to prevent the situation that the registered information related to the relevant content reception apparatus 200 is deleted or the content transmission is interrupted.

### Embodiment 7

Hereinafter, Embodiment 7 will be described.

In Embodiment 7 of the invention, the description will be made on a method of updating the counter value (Count) that the device information check section 1804 of the content transmission apparatus 100 manages, from the side of the content reception apparatus 200 at an arbitrary timing.

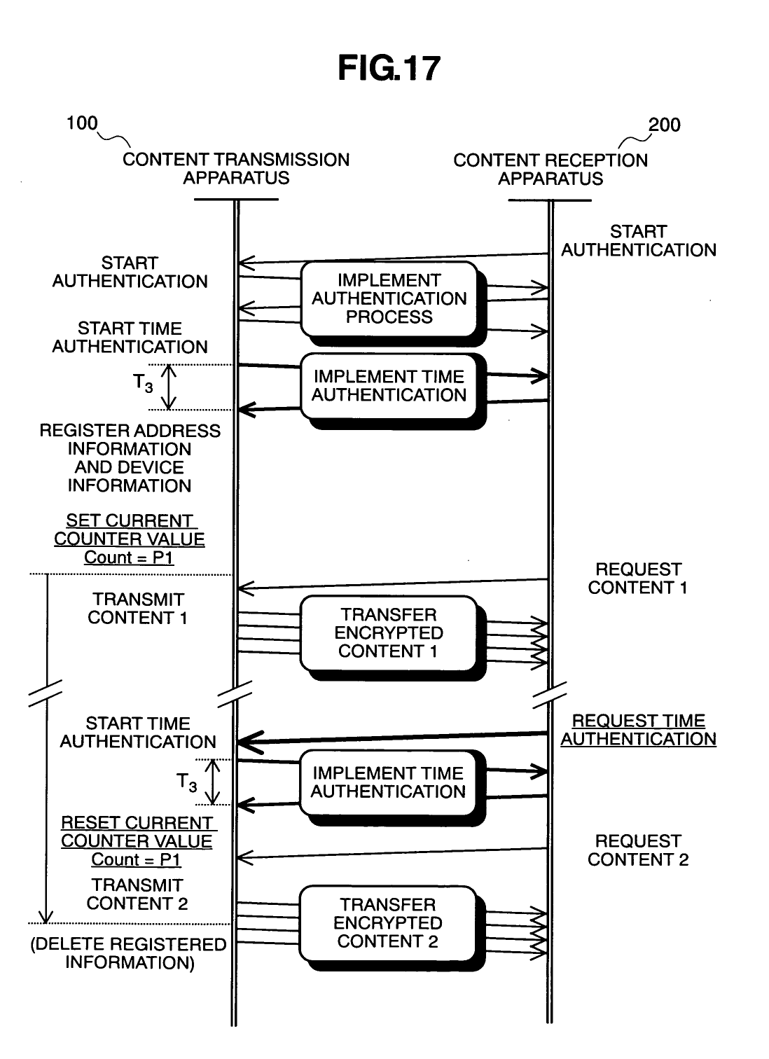

FIG. 17 shows an example of a procedure for implementing the time authentication between the content transmission apparatus 100 and the content reception apparatus 200. The left side represents the content transmission apparatus 100, and the right side represents the content reception apparatus 200. The time (T3) shown in FIG. 6 is used as the predetermined value in the time authentication.

As described above, when an authentication request is issued from the content reception apparatus 200 to the content transmission apparatus 100, a series of the authentication process steps starts. Then, when having implemented and succeeded in the time authentication, the content transmission apparatus 100 registers the address information and device specific information related to the relevant content reception apparatus 200 to the device information registry section 108, the device information check section 1804 sets the value of the counter setting value (CountMax) to the current counter value (Count) in the same manner as described above, starts the timer circuit 107, and then goes into a state waiting for receiving requests from the relevant content reception apparatus 200 and the other apparatuses on the network.

Herein, in the embodiment, it is assumed that when the current counter value reaches 0 (Count=0), the content transmission apparatus 100 deletes the information related to the relevant content reception apparatus 200 registered in the device information registry section 108.

Under such circumstances, the content reception apparatus 200 generates and transmits a transmission request of content 1 to the content transmission apparatus 100, and the content transmission apparatus 100 encrypts and transmits the content 1. After having completed reception of the content 1 and when wanting to further receive content 2, the content reception apparatus 200 generates an implementation request of the time authentication and transmits the request to the content transmission apparatus 100. Upon reception of the request, the content transmission apparatus 100 implements the time authentication using the timer circuit 107, and when succeeded, sets the counter setting value (CountMax) to the current counter value (count) again. Subsequently, the content reception apparatus 200 generates a transmission request of the content 2 and transmits the request to the content transmission apparatus 100.

In the above description, the content reception apparatus 200 transmits the implementation request of the time authentication between the reception of the content 1 and the reception of the content 2. However, the reception apparatus can also transmit the implementation request periodically or at an arbitrary timing (for example, before the viewing/recording reservation, in the power input).

Further, there is another method that the content reception apparatus 200 inquires the content transmission apparatus 100 about the current counter value (Count), and transmits the implementation request of the time authentication when the counter value is below the predetermined threshold.

Thus, the content reception apparatus 200 transmits the implementation request of the time authentication to the content transmission apparatus 100 to implement the time authentication, which makes it possible to control so that the registered information related to the relevant reception apparatus 200 is not deleted in the side of the content transmission apparatus 100.

### Embodiment 8

Hereinafter, Embodiment 8 will be described.

In Embodiment 8 of the invention, the description will be made on a method of transmitting content using the wireless LAN between a content transmission apparatus 1800 and content reception apparatus 1850 that are equipped with both the wired LAN and the wireless LAN.

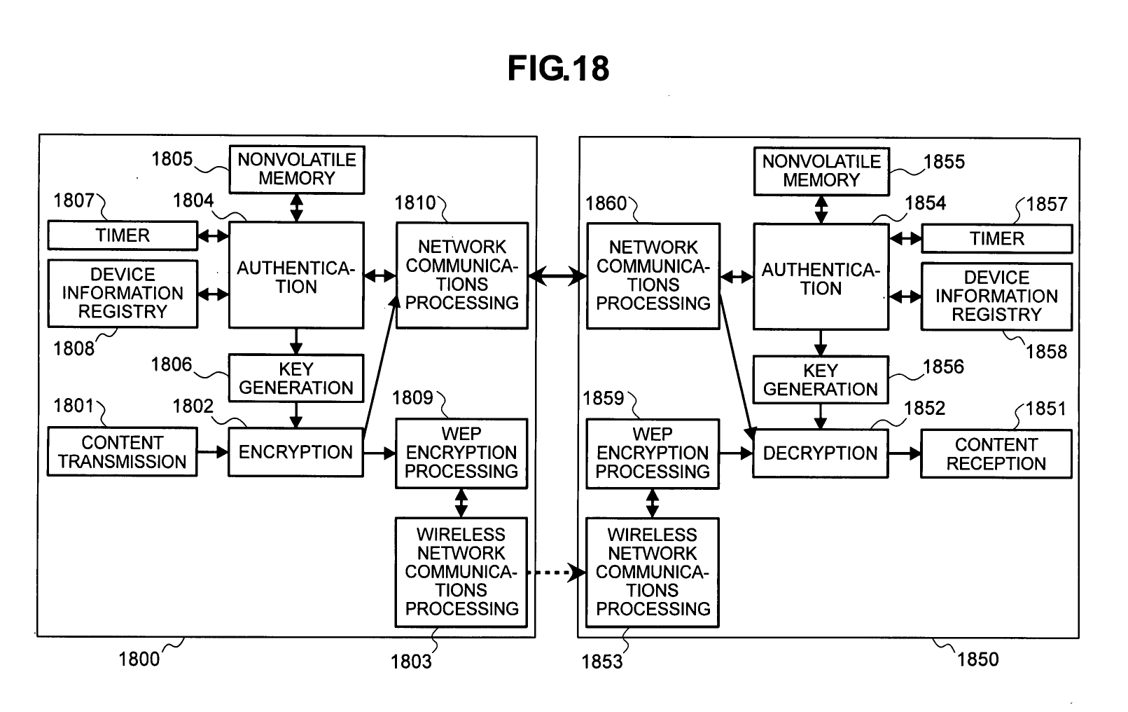

FIG. 18 shows the content transmission apparatus 1800 and content reception apparatus 1850 connected through the wired LAN and the wireless LAN, where network communications processing circuits 1810 and 1860 are respectively used for the connection with the wired LAN, and wireless network communications processing circuits 1803 and 1853 are respectively used for the connection with the wireless LAN.

As the wireless LAN has lower transmission efficiency/speed than the wired LAN, there is a possibility to fail the time authentication when it is implemented while the content with high image quality is being transmitted on the wireless LAN. It is thought that the time authentication would be implemented, such as by retrying, until it is achieved. However, the content transmission may be interrupted or the image may be deteriorated during the time authentication process.

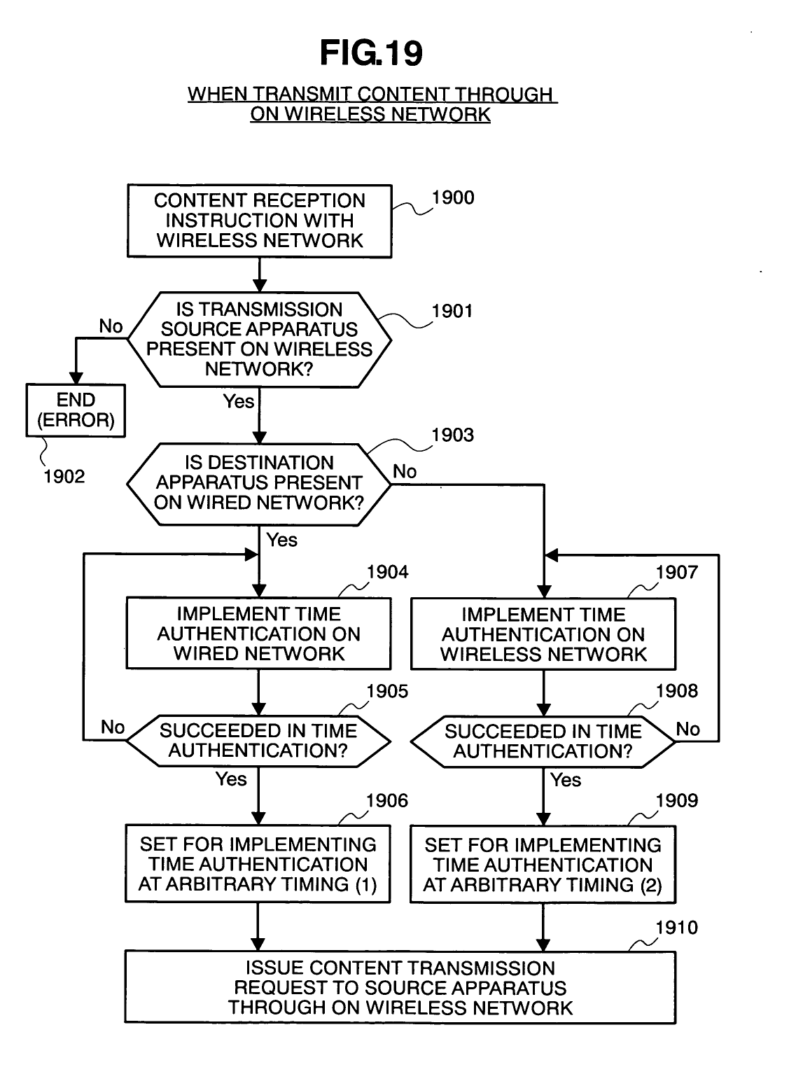

FIG. 19 shows an example of a series of processing steps for implementing the time authentication in the case where the content is transmitted between the content transmission apparatus 1800 and the content reception apparatus 1850 on the wireless LAN.

First, when a user requests to receive content of the content transmission apparatus 1800 on the content reception apparatus 1850 (Step 1900), the content reception apparatus 1850 checks whether the relevant content transmission apparatus 1800 is present on the wireless LAN (Step 1901). As a result, when the relevant transmission apparatus 1800 is absent, the reception apparatus 1850 ends the process (Step 1902). While, when the relevant transmission apparatus 1800 is present, the reception apparatus 1850 checks whether the relevant content transmission apparatus 1800 is present on the wired LAN (Step 1903).

Herein, when the transmission apparatus 1800 is also present on the wired LAN, the reception apparatus 1850 implements the time authentication with the transmission apparatus 1800 on the wired LAN (Step 1904) As a result (Step 1905), when failed in the time authentication, the reception apparatus 1850 retires the time authentication on the wired LAN. While when succeeded in the time authentication, as illustrated in the Embodiments 5 to 7, the reception apparatus sets the time authentication to be implemented periodically or at an arbitrary timing (Step 1906).

On the other hand, when the relevant transmission apparatus 1800 is absent on the wired LAN, the reception apparatus 1850 implements the time authentication with the transmission apparatus 1800 on the wireless LAN (Step 1907). As a result (Step 1908), when failed in time authentication, the reception apparatus 1850 retries the time authentication on the wireless LAN. While when succeeded in the time authentication, the reception apparatus sets the time authentication to be subsequently implemented at arbitrary timing on the wireless LAN (Step 1909).

Finally, the content reception apparatus 1850 issues a content transmission request to the content transmission apparatus 1800 through the wireless LAN and starts receiving the content (Step 1910).

Herein, in the Step 1909, the subsequent time authentication is implemented on the wireless LAN. However, it is also possible that the content reception apparatus 1850 checks whether the content transmission apparatus 1800 is present on the wired LAN as described in Step 1903, every time the time authentication is required, and carries out the process of Step 1904 and the following steps when the transmission apparatus 1800 is present on the wired LAN.

Further, the embodiment has exemplified the wired LAN, which maybe substituted by other wired networks such as IEEE1394 and USB.

### Embodiment 9

Hereinafter, Embodiment 9 will be described.

As described above in Embodiment 8, the wireless LAN has lower transmission efficiency/speed than the wired LAN, so that it is necessary to consider the timing of implementing the time authentication so as not to put a load on the content transmission on the wireless LAN.

Thus, in Embodiment 9 of the invention, the description will be made on a method of implementing the time authentication on the wireless LAN in the content transmission apparatus 500/1800 and content reception apparatus 600/1850, which are all equipped with wireless LAN.

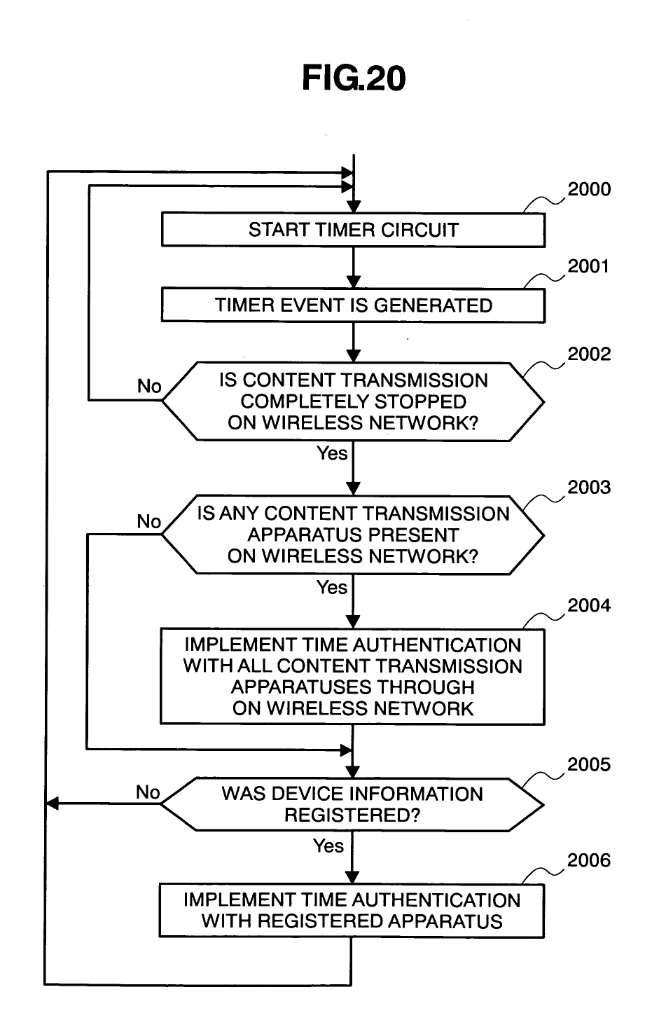

FIG. 20 shows an example of a series of processing steps that the content transmission apparatus or content reception apparatus implements the time authentication on the wireless LAN.

First, the apparatus starts the timer circuit 507/607/1807/1857 at an arbitrary timing, and sets the timer circuit so that a timer event is generated after a given time has passed (Step 2000). When the timer event is generated (Step 2001), the apparatus checks whether the own apparatus currently transmits or receives content on the wireless LAN (Step 2002), and when currently transmitting or receiving, the apparatus starts the timer circuit for generating a next timer event without implementing the time authentication (Step 2000).

On the other hand, when the own apparatus completely stops the content transmission/reception, the apparatus checks whether any content transmission apparatus is present on the wireless LAN (Step 2003), and when present, implements the time authentication with all the content transmission apparatuses present on the wireless LAN (Step 2004).

Next, the apparatus checks whether the device information is registered in the device information registry section 508/608/1808/1858 within the own apparatus (Step 2005), and when registered, implements the time authentication with the content reception apparatus whose information has been registered (Step 2006).

Thus, the time authentication is implemented between the necessary content transmission apparatus and content reception apparatus while the content transmission is stopped on the wireless LAN, which makes it possible to reduce unnecessary load in the content transmission.

Herein, in Step 2002, there may be a method to confirm not only the own apparatus but also the other apparatuses that the content transmission is not carried out on the wireless LAN.

Further, in Step 2004, it is also possible to implement the time authentication only with the necessary content transmission apparatus (for example, the apparatus frequently used or the apparatus where a recording reservation has been made).

In Step 2006, there may be a method to implement the time authentication only with the apparatus requiring the time authentication (for example, the apparatus with the counter value below the predetermined threshold, or the apparatus where a recording reservation has been made), of the registered content reception apparatuses.

The order of Steps 2003 to 2004 and Steps 2005 to 2006 may vary. There is another method that carries out either Steps 2003 to 2004 or Steps 2005 to 2006.

As has been described with regard to the embodiments of the invention, in the content transmission using a wired or wireless LAN, it is possible to provide a content transmission apparatus and reception apparatus capable of implementing copy protection to prevent unauthorized duplication of content as well as limiting the authorized viewing and duplication of content to the range of personal use, because the content transmission apparatus implements the authentication of an authentication request from the content reception apparatus and registers the address information and device specific information of the relevant content reception apparatus. However, it is needless to say that the same advantages as described above can be obtained when the content reception apparatus authenticates the content transmission apparatus and registers the address information and device specific information of the relevant content transmission apparatus. Further, the description has been made assuming that the object to be transmitted through the network is the content, such as video information, which is transmitted and received by the content transmission apparatus and the reception apparatus. This is the same for the other types of information than the image information, and it is needless to say that the invention is also applicable to information processing apparatus for inputting and outputting these types of information.

Further, the time authentication is implemented periodically or accordingly between the content transmission apparatus and the content reception apparatus, which makes it possible to dynamically manage the registered information content such as the address information and device specific information.

According to the invention, in the content transmission using a wired or wireless LAN installed in a house, it is possible to provide a content transmission apparatus and reception apparatus capable of implementing copy protection to prevent unauthorized duplication of content as well as limiting the authorized viewing and duplication of content to the range of personal use.

The foregoing invention has been described in terms of preferred embodiments. However, those skilled, in the art will recognize that many variations of such embodiments exist. Such variations are intended to be within the scope of the present invention and the appended claims.

What is claimed is:

1. A content reception apparatus comprising:
a network communications processing section for transmitting and receiving data through wired and wireless networks;
a content reception processing section for issuing and transmitting a content transmission request to a content transmission apparatus connected through the networks, and receiving content from the content transmission apparatus from the network communications processing section;
an authentication section for issuing and transmitting an authentication request to the content transmission apparatus, and determining the authentication of the authentication request from the content transmission apparatus;
a decryption section for generating key information based on information acquired by carrying out the authentication process in the authentication section to carry out a decryption process of the content received from the content transmission apparatus, by the key information; and
a network connection confirmation section for checking whether the content transmission apparatus is connected to the wired and wireless networks,
wherein when the content transmission apparatus is connected to both the wired and wireless networks, the content reception apparatus issues an authentication request to the content transmission apparatus through the wired network, responding to a time confirmation request transmitted from the content transmission apparatus where the time until the arrival of the response is measured, and when normally succeeded in the authentication, issuing a content transmission request through the wired or wireless network.

2. A content reception apparatus comprising:
a network communications processing section for transmitting and receiving data through a network;
a content reception processing section for issuing and transmitting a content transmission request to a content transmission apparatus connected through the network, and receiving content from the content transmission apparatus from the network communications processing section;
an authentication section for issuing and transmitting an authentication request to the content transmission apparatus, and determining the authentication of the authentication request from the content transmission apparatus;
a decryption section for generating key information based on information acquired by carrying out the authentication process in the authentication section to carry out a decryption process of the content received from the content transmission apparatus, by the key information; and
a state detection section for monitoring the content transmission state, and detecting a state where the content transmission is not carried out,
wherein when detecting the state where the content transmission is not carried out on the network, the content reception apparatus issues the authentication request to the content transmission apparatus present on the network, responding to a time confirmation request transmitted from the content transmission apparatus where the time until the arrival of the response is measured.

3. A content transmission apparatus comprising:
a network communications processing section for transmitting and receiving data through a network;
a transmission content generation section for supplying content to be transmitted to a content reception apparatus connected through the network, to the network communications processing section;
an authentication section for receiving an authentication request from the content reception apparatus and determining the authentication of the authentication request, while issuing an own authentication request to the content reception apparatus;
an encryption section for generating key information based on information acquired by carrying out the authentication process in the authentication section to carry out an encryption process of the content to be transmitted to the content reception apparatus, by the key information;
a timer section for transmitting an authentication request or a time confirmation request to the content reception apparatus, and measuring the time until receiving a response to the request;
a device information management section for registering and managing device information of the relevant content reception apparatus; and
a state detection section for monitoring the content transmission state, and detecting a state where the content transmission is not carried out,
wherein the device information management section, when the measurement result in the timer section does not exceed a predetermined value, registers address information of said content reception apparatus and the device information specific to said apparatus previously stored at the manufacturing time, and
when detecting the state where the content transmission is not carried out on the network, the device information management section applies the time measurement to the registered content reception apparatus by the timer section, thereby to control the registered information content in accordance with the measurement result.

4. A content reception method of a content reception apparatus for issuing and transmitting a content transmission request to a content transmission apparatus connected to wired and wireless networks and receiving content from the content transmission apparatus, the method comprising the steps of:
issuing and transmitting an authentication request to the content transmission apparatus, while determining the authentication of an authentication request from the content transmission apparatus;
checking whether the content transmission apparatus is connected to the wired and wireless networks; and
generating key information based on information acquired when determining the authentication of the authentication request, and carrying out a decryption process of the content received from the content transmission apparatus by the key information,
wherein when the content transmission apparatus is connected to both the wired and wireless networks, the content reception apparatus issues an authentication request to the content transmission apparatus through the wired network, responding to a time confirmation request transmitted from the content transmission apparatus where the time until the arrival of the response is measured, and when normally succeeded in the authentication, issuing the content transmission request through the wired or wireless network.

5. A content reception method of a content reception apparatus for issuing and transmitting a content transmission request to a content transmission apparatus connected to a network and receiving content from the content transmission apparatus, the method comprising the steps of:
issuing and transmitting an authentication request to the content transmission apparatus, while determining an authentication request from the content transmission apparatus;
monitoring the content transmission state and detecting a state where the content transmission is not carried out; and
generating key information based on information acquired when determining the authentication of the authentication request, and carrying out a decryption process of the content received from the content transmission apparatus by the key information,
wherein when detecting the state where the content transmission is not carried out on the network, the content reception apparatus issues the authentication request to the content transmission apparatus present on the network, responding to a time confirmation request transmitted from the content transmission apparatus where the time until the arrival of the response is measured.

6. A content transmission method of a content transmission apparatus for supplying content to a content reception apparatus connected to a network, the method comprising the steps of:
receiving an authentication request from the content reception apparatus and determining the authentication of the authentication request, while issuing an own authentication request to the content reception apparatus;
transmitting the authentication request or a time confirmation request to the content reception apparatus, and measuring the time until receiving a response to the request;
generating key information based on the information acquired when determining the authentication of the authentication request, and carrying out an encryption process of the content to be transmitted to the content reception apparatus by the key information;
registering and managing the device information of the content reception apparatus; and
monitoring the content transmission state, and detecting a state where the content transmission is not carried out,
wherein when the measurement result of the time measurement step does not exceed a predetermined value, the content transmission apparatus registers address information of said content reception apparatus and the device information specific to said apparatus previously stored at the manufacturing time, and when detecting the state where the content transmission is not carried out on the network, controls the registered content information in accordance with the measurement result of the step where the time measurement is applied to the content reception apparatus whose information has been registered.
